(19) United States
(12) Patent Application Publication
(10) Pub. No.: US 2021/0049787 A1
(43) Pub. Date: Feb. 18, 2021

(54) APPARATUS AND METHOD FOR PROCESSING COLOUR IMAGE DATA

(71) Applicant: THE UNIVERSITY OF MANCHESTER, Manchester (GB)

(72) Inventors: Robert James LUCAS, Manchester (GB); Annette Elizabeth ALLEN, Manchester (GB)

(21) Appl. No.: 17/050,815

(22) PCT Filed: Apr. 25, 2019
(86) PCT No.: PCT/GB2019/051155

§ 371 Date: Oct. 26, 2020

(30) Foreign Application Priority Data
Apr. 27, 2018 (GB) 1806945.0

(51) Int. Cl. G06T 7/90; H04N 9/67; H04N 9/64; H05B 47/155

(52) U.S. Cl. CPC G06T 7/90; H04N 9/67; G09G 5/02; H05B 47/155; G06T 2207/10024; H04N 9/646

(57) ABSTRACT

Embodiments of the present invention provide a computer-implemented method (200) of processing colour image data which comprises determining (220, 230) output colour information values based on first and second tristimulus colour spaces indicative of first and second cone spectral sensitivity functions, wherein the determining (220, 230) comprises determining a first one of the output colour information values based on a first tristimulus colour space and determining a second one of the output colour information values based on a second tristimulus colour space to be within a predetermined range of the first one of the output colour information values, and outputting (240) the output colour information values.

### TECHNICAL FIELD

Aspects of the invention relate to a method, apparatus, and device for processing colour information data.

### BACKGROUND

It is continually desired to form images which are more appealing to a viewer. Images may be formed as static images, such as printed or otherwise formed on a media or electronically formed on a display device. In the field of printing, innovations have included new ink or toner substances, methods of applying substances to the media and advancements in the media. Over recent years many new display technologies have emerged from cathode ray tube (CRT) to liquid crystal display (LCD), light emitting diode (LED) and, more recently, organic light emitting diode (OLED). Amongst the drivers for the development of these technologies has been the desire for more attractive images. More recent interests include controlling displays to modulate their impact on one or more of circadian clocks, sleepiness and alertness, and producing brighter, clearer images for viewer consumption. Other drivers include the desire for the more accurate reproduction of colours and images whilst taking into account the limitations of human colour perception, such as when viewed under varying light conditions and on varying surfaces.

It is an object of embodiments of the invention to at least mitigate one or more of the problems of the prior art.

### SUMMARY OF THE INVENTION

According to aspects of the present invention there is provided methods and apparatus as set forth in the appended claims.

According to an aspect of the present invention, there is provided a computer-implemented method of processing colour image data, comprising determining output colour information values based on first and second tristimulus colour spaces indicative of first and second cone spectral sensitivity functions, wherein the determining comprises determining a first one of the output colour information values based on a first tristimulus colour space and determining a second one of the output colour information values based on a second tristimulus colour space to be within a predetermined range of the first one of the output colour information values, and outputting the output colour information values.

The determining may be performed by a processing means, such as an electronic processing device.

According to an aspect of the present invention, there is provided an apparatus for processing colour image data, comprising processing means arranged to determine output colour information values based on first and second tristimulus colour spaces indicative of first and second cone spectral sensitivity functions, wherein the determining comprises determining a first one of the output colour information values based on a first tristimulus colour space and determining a second one of the output colour information values based on a second tristimulus colour space to be within a predetermined range of the first one of the output colour information values, and output means arranged to output colour information values.

The input means may be arranged to receive the first plurality of colour information values comprising a plurality of discrete values.

The processing means is optionally arranged to map the colour information values in the first colour space such that a perceived colour of the image data is substantially maintained after mapping to the output colour information values.

The processing means may be arranged to determine the output colour information values to produce a predetermined melanopsin response.

Optionally the processing means is arranged to determine the output colour information values in a X₁₀Y₁₀Z₁₀Y₂M colour space.

The first tristimulus colour space may comprise a 10° X₁₀Y₁₀Z₁₀ colour space.

The second tristimulus colour space may comprise a 2° X₂Y₂Z₂ colour space.

The output means is optionally arranged to output the image data utilising at least four colour primaries.

The output means may be arranged to output the image data utilising at least five colour primaries.

The five colour primaries may comprise at least some of violet, cyan, yellow, green, and red colour primaries.

According to an aspect of the present invention, there is provided an imaging device comprising a plurality of light detecting devices, each being arranged to detect light in a respective wavelength range. The imaging device may be arranged to output colour information comprising four or more colour information values, one or more of which describes colour in a first tristimulus colour space and one or more of which describes colour in a second tristimulus colour space reflecting different sets of cone spectral sensitivities.

According to an aspect of the present invention, there is provided a device for light emission, comprising a plurality of light emitting devices, each device being arranged to output light in a respective wavelength range, control means for controlling an output of each of the plurality of light emitting devices, wherein the control means is arranged to determine the respective output of each of the light emitting devices according to first and second tristimulus colour spaces, such that one or more colour information values is within a predetermined range of one or more colour information values based on the second colour space.

Optionally one or more of the plurality of light emitting devices comprises a peak transmission or emission wavelength of below 460 nm.

One or more of the plurality of light emitting devices optionally comprises a peak transmission or emission wavelength of between 460 nm and 510 nm.

One or more of the plurality of light emitting devices may comprise a peak transmission or emission wavelength of between 510 nm and 560 nm.

One or more of the plurality of light emitting devices optionally comprises a peak transmission or emission wavelength of between 560 nm and 600 nm.

One or more of the plurality of light emitting devices may comprise a peak transmission or emission wavelength of above 600 nm.

The first tristimulus colour space optionally comprises a 10° X₁₀Y₁₀Z₁₀ colour space.

The second tristimulus colour space optionally comprises a 2° X₂Y₂Z₂ colour space.

Optionally at least one of the colour information values based on the first and second tristimulus colour spaces to be within a predetermined range is the Y₁₀ and Y₂ value respectively.

### BRIEF DESCRIPTION OF THE DRAWINGS

Embodiments of the invention will now be described by way of example only, with reference to the accompanying figures, in which:

FIG. 1 shows results of experimental data pertaining to an embodiment of the invention;

FIG. 2 shows a method according to an embodiment of the invention;

FIG. 3 shows example spectra of colour primaries according to an embodiment of the invention;

FIG. 4 shows an apparatus according to an embodiment of the invention;

FIG. 5 shows a device according to an embodiment of the invention;

FIG. 6 shows a method according to an embodiment of the invention;

FIG. 7 shows an imaging device according to an embodiment of the invention; and

FIG. 8 shows a plurality of spectral sensitivities according to an embodiment of the invention.

### DETAILED DESCRIPTION

A colour model is used to describe ways in which colours can be represented as tuples of numbers, often as three or four values representing colour components. One such colour model is the RGB colour model in which red, green and blue colour values are used. The RGB colour model is widely used in image capture, in visual displays and lighting. RGB colour model or architecture is used in image capture devices (cameras, video cameras) to record spatial/temporal patterns in colour using three sensing colour planes (R, G and B); in visual displays to recreate spatial patterns in colour using three emitting colour planes (R, G and B); and in the design of artificial lighting to control a luminance/chromaticity of ambient light sources by using three emitting primaries (R, G and B).

Artificial lights and visual displays with more than 3 colour planes or primaries, or those which do not utilise conventional RGB primaries, can be beneficial for a number of reasons. For example, an addition of a fourth colour plane (e.g. a visual display comprised of violet, cyan, green and red pixels) can allow selective control of non-image forming light responses (e.g. alertness, melatonin release) by adjusting the excitation of melanopsin while maintaining the colour and luminance of an original RGB image or moving image. Visual displays with more than 3 colour planes can also increase colour gamut, and may show desirable improvements in visual appearance, including in metabrightness. Metabrightness is defined here as a percept of brightness or light intensity (intensity of light) that originates with melanopsin and/or rod excitation.

In a three-primary display, such as an RGB display, perceived brightness is controlled by modulating luminance, which is a property of emitted light relating to its ability to excite cone photoreceptors. The quality of metabrightness allows for the possibility that rods and melanopsin can also influence appearance of the display. The spectral sensitivities of rods and melanopsin peak in the 480-500 nm range and are distinct from that of cones. Metabrightness and luminance may therefore be distinct, different, qualities of light. In the case of a display with more than 3 primaries, such as 4 primaries, different outputs may be produced which are matched in luminance but differ in metabrightness. For example, the 4 primary display may comprise one primary which has a peak output in a cyan part of the visible light spectrum, and combinations of the primaries may be matched for luminance but differ substantially in an output of the cyan primary may be produced. In this case, the setting with enhanced cyan primary emission would have higher metabrightness.

With any display or image capture apparatus that uses more than 3 primaries, or uses 3 primaries other than RGB, a method is often required to recreate colour information. By recreating colour information it is meant converting between first and second colour spaces or colour coordinate systems. This can be achieved by mapping colour information values in one colour model i.e. a three-colour model (e.g. those in RGB) to a colour space e.g. CIE XYZ tristimulus values.

An important consideration in this process, however, is that the spectral sensitivity of the human retina is non-uniform. The human retina contains a central zone, termed variously area centralis, fovea centralis or macula lutea, above which sits a yellowish pigment called luteal pigment. The luteal pigment applies a spectral filter to the light reaching cones in the central part of our field of view that is absent for cones in more peripheral parts of the retina.

In general terms, when a light of given spectral composition is shone across the retina, the light reaching foveal cones will have lower shorter wavelength (‘blue’) than light reaching more peripheral cones content due to the filtering effects of luteal pigments. As colour perception relies upon assessments of the spectral quality of incident light, the effective ‘colour’ of the central part of the visual field is therefore expected to differ from that of the surrounding parts of the visual field. Under natural viewing conditions, the human visual system is not aware of this difference, and does not generally perceive a discontinuity in colour across the central part of the visual field. However, it is possible to reveal this effect by viewing a white surface through particular coloured filters, resulting in a central reddish spot appearing, termed “Maxwell's spot”.

The present inventors have observed that when viewing uniform colours or spatial patterns of colour using more than three primaries or colour planes, such as a non-RGB, more than 3 primary visual display device (in one example a display device comprising five primaries: violet, cyan, green yellow and red), for many colours, including white, the inclusion of cyan in certain spectra (specifically those with high meta-brightness, which will be explained later) caused the effect of a strong perception of Maxwell's spot. The resulting images thus looked unnatural and inaccurate compared to their pre-mapped forms. Thus a problem has been observed with images formed using such non-RGB colour models, or display devices comprising more than three colour primaries.

Because of the spatial non-uniformity of the spectral sensitivity of the human retina, two distinct XYZ tristimulus values are known, based on the spectral sensitivity of the central 2° or the central 10° of the human retina. These are known as CIE 1931 2° Standard Observer and CIE 1964 10° Standard Observer. These will be referred to as the 2° and 10° degree colour spaces.

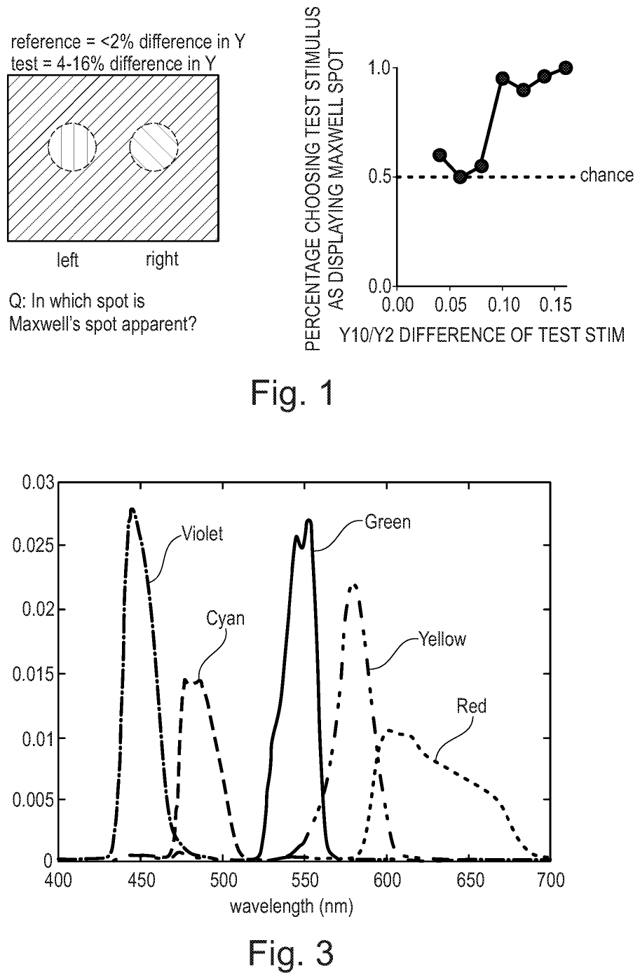

It has been determined by the present inventors that the appearance of Maxwell's spot correlates strongly with a difference in one of the colour values between the 2° and 10° degree colour spaces. In particular, it has been determined that Maxwell's spot may be observed more often with more than a predetermined difference in Y values between the 2° and 10° spaces. Experimental results indicative of this are shown in FIG. 1.

FIG. 1a shows a schematic showing a stimulus presentation paradigm. Individuals were asked to choose in which of two test colours (left or right) Maxwell's spot was apparent. The reference colour had <2% difference in 10° and 2° Y coordinates, the test image had between 2 and 16% difference in 10° and 2° Y coordinates. Reference and test images were presented in a randomised location (varying appearance on left/right of the screen).

FIG. 1b shows a percentage of trials in which individuals reported the test image as showing Maxwell's spot, as a function of % difference in 10° and 2° Y coordinates for the test image. At percentage differences of more than 10%, the detection of Maxwell's spot occurred in almost all occasions. For percentage differences of less than 10%, the selection was at chance.

Thus it has been determined by the present inventors that limiting a difference between one of the tristimulus values between the 2° and 10° spaces may reduce an appearance of a colour defect. In particular limiting a difference between Y₂ and Y₁₀ values to a predetermined value prevents, or reduces a likelihood, of the appearance of Maxwell's spot.

Embodiments of the invention comprise determining output colour information values that account for differences in cone spectral sensitivity between central and more peripheral retina.

In some embodiments, output colour information values are determined taking account of first and second tristimulus colour spaces reflecting different sets of cone spectral sensitivities, where a first one of the output colour information values in a first tristimulus colour space is determined to be within a predetermined range of a second one of the output colour information values in a second tristimulus colour space.

In some embodiments, a mapping is arranged such that Y₂ and Y₁₀ differ by no more than 10%. However other colour information values and other predetermined ranges may be envisaged. In some embodiments, the predetermined difference may be 5% or 8%. In other embodiments, the predetermined range is 15%. Some embodiments of the invention may comprise a step of determining a permissible difference between one of the tristimulus values between the 2° and 10° spaces.

As is described above, the mapping may still be arranged such that a perceived colour or colours of the image data is substantially maintained after mapping. Therefore, a likelihood of an appearance of a perceptible colour defect, such as an appearance of Maxwell's spot, may be reduced by limiting a difference between Y₂ and Y₁₀ values to a predetermined value in embodiments of the invention.

It has also been determined by the present inventors that current RGB displays show a limited divergence in Y₂ and Y₁₀ values, which is consistent with limited appearance of Maxwell's spot with conventional displays. Stimuli in which Maxwell's spot was observed typically had >10% difference in Y₂ and Y₁₀ values.

It was noted by the present inventors that limiting the difference between Y₂ and Y₁₀ values during mapping to a predetermined value (such as no more than 10%) limits the appearance of Maxwell's spot. Thus, in some embodiments the mapping is arranged such that Y₂ and Y₁₀ differ by no more than 10%; however other colour information values and other predetermined ranges may be envisaged. In some embodiments, the predetermined range is 5%. In other embodiments, the predetermined range is 15%. As is described above, the mapping may still be arranged such that a perceived colour or colours of the image data is substantially maintained after mapping.

Minimising the difference between Y₂ and Y₁₀ assumes that the most complete solution to eliminating Maxwell's spot is to have no difference between Y₂ and Y₁₀. Another approach is to rather try to recreate differences in Y₂ vs Y₁₀ that we experience in everyday life (in which we rarely if ever experience Maxwell's spot). Thus, in some embodiments, the mapping is arranged such that Y₂ and Y₁₀ differ by no more than occurs in real world (or by no more than a predetermined value such as 10%). The present inventors have defined the target or maximum permissible difference from measurements of hyper-spectral images of real world scenes. It is envisaged that the maximum permissible difference between colour spaces may vary according to colour. The present inventors have determined that Maxwell's spot is not apparent when the difference in Y₂ vs Y₁₀ matches or at least approximates that expected in the real world.

If there are two potential target values for difference between Y₂ and Y₁₀ (0 or that expected in nature) that eliminate Maxwell's spot, this raises the question of which is preferred. The present inventors considered whether stimuli with the same X₁₀Y₁₀Z₁₀ coordinates had the same colour if Y₂ is arranged so that Y₂-Y₁₀=0 or Y₂-Y₁₀=expected real world value. The present inventors deduced that colours that have Y₂ and Y₁₀ values that differ substantially from the natural difference in Y₂ and Y₁₀ look less natural, and so the preferred choice may be to render or map in as close to the natural difference as possible.

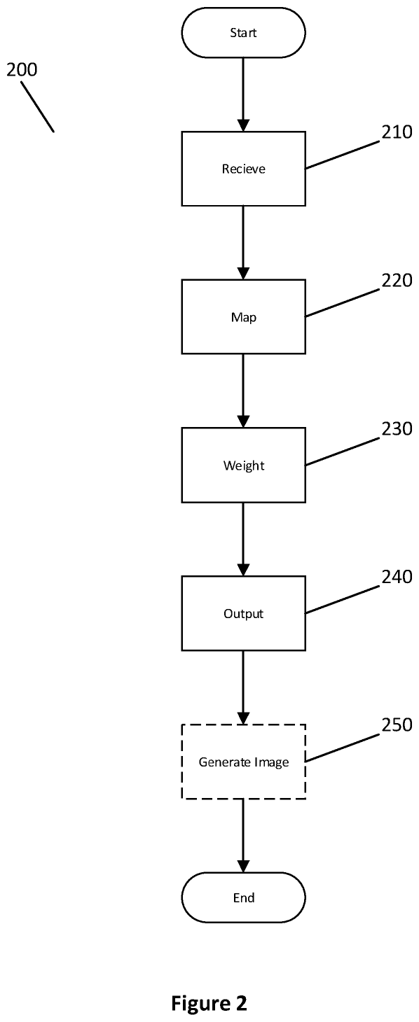

FIG. 2 illustrates a method 200 according to an embodiment of the invention. The method 200 is a method of processing colour image data. The method 200 processes the image data to reduce a likelihood of a colour defect, such as Maxwell's spot, being observed. The method 200 receives first image data and determines second image data whilst controlling or limiting an appearance of the colour defect in the second image data as will be explained.

The method 200 comprises a step 210 of receiving image data comprising colour information values in an input, or first, colour information space. The colour information values may comprise a plurality of discrete numerical values that are each associated with a respective portion of the image data. The numerical values may be tristimulus values. The input colour space may be an RGB colour space. In some embodiments, the colour information values may be indicative of a spectral power distribution representative of the image data. The colour information values may each be associated with a respective location in the image data. For example, a first tristimulus value may be indicative of a colour at a first location in the image data, a second tristimulus value indicative of a colour at a second location in the image data, etc. The tristimulus values may be RGB or XYZ colour values.

The method 200 comprises a step 220 of mapping the colour information values received in step 210 to colour information values in a second colour space.

In some embodiments, the method 200 may comprise a step (not shown) of defining the second colour space to which the received colour information values in the first colour information space are to be mapped.

The colour information values in the second colour space comprise at least one value in first and second tristimulus colour spaces. The first tristimulus colour space may be a 2° tristimulus colour space and the second tristimulus colour space may be a 10° tristimulus colour space in some embodiments of the invention. Thus, in some embodiments of the invention, the colour information values in the second colour space comprise at least one output colour information value in both 2° and 10° tristimulus colour spaces. The value may be a Y value i.e. Y in both 2° and 10° XYZ tristimulus colour spaces. In some embodiments of the invention, the colour information values in the second colour space may be defined as:

X_{10T}Y_{10T}Z_{10T}Y_{2T}

according to first and second, i.e. 2° and 10°, XYZ tristimulus colour spaces. It will be understood that X, Y, Z refer to the particular tristimulus value of the CIE tristimulus colour space and the subscript denotes the 2° or 10° tristimulus colour space, respectively.

In some embodiments, step 220 comprises determining tristimulus values using one of the tristimulus colour spaces i.e. one of both 2° and 10° tristimulus colour spaces. In some embodiments, step 220 comprises determining tristimulus values using the 10° tristimulus colour space.

In a subsequent sub-step forming part of step 220, a value for at least one of the second colour space values is determined to be within a maximum permissible range. The maximum permissible range is determined in the other tristimulus colour space. In the described embodiment the other tristimulus colour space is the 2° colour space. In some embodiments, the sub-step comprises determining the maximum permissible range of the Y₂ colour coordinate in dependence on the Y₁₀ colour coordinate. It will be noted that the term ‘maximum permissible range’ does not imply that the value of Y₂ is greater than Y₁₀, but merely indicates the maximum permissible difference between the colour coordinates. For example, where the maximum permissible range of Y₂ is 10% from Y₁₀, an example of step 220 comprises determining the permissible range of Y₂ as Y₁₀±(Y₁₀×0.1).

As a result of step 220, the colour information values in the second colour space may be determined as X_{10T}Y_{10T}Z_{10T}Y_{2T}. The subscript is indicative of the tristimulus colour space and T being indicative of these being ‘target’ output colour information values. As a result of step 220, second colour space coordinates are defined having at least four coordinate values which may be:

X_{10T}Y_{10T}Z_{10T}Y_{2T}.

In some embodiments the colour information values in the second colour space may comprise an additional value, such as a fifth value, indicative of melanopsin excitation or metabrightness, which may be M_{T}.

The resulting image data comprising the colour information values in the second colour space, may be determined to be output using a plurality of colour primaries. By colour primaries, in some embodiments it is meant that a plurality of light emitters of respective wavelength ranges are used. In some embodiments, at least four colour primaries are used. In some embodiments, five colour primaries are used. In some embodiments, one of the colour primaries may be cyan. The plurality of colour primaries may comprise at least some of violet, cyan, yellow, green, and red colour primaries. Advantageously, including a fifth colour primary may improve control of the predicted difference in colour information values calculated for the central and peripheral 2° and 10° cones by reducing the difference between Y₂ and Y₁₀ values whilst retaining colour and luminance, and in some embodiments even melanopsin contrast. However, it will be appreciated that embodiments of the invention may be envisaged with four or more colour primaries.

FIG. 3 shows example spectral power distributions of five colour primaries which may be used with an embodiment of the invention. The illustrated five colour primaries comprise violet, cyan, yellow, green, and red colour primaries. It will be appreciated that the illustrated spectral power distributions are provided as an example and that other spectral power distributions may be used.

It will be appreciated that each of the plurality of colour primaries may be described in the second colour space i.e. using the second plurality of colour information values. For example, in embodiments where the second colour space comprises the XYZ colour space according to the 2° and 10° colour spaces, applying X₁₀Y₁₀Z₁₀ and Y₂ cone fundamentals, a melanopic spectral efficiency function to the spectral power distributions of violet, cyan, yellow, green, and red colour primaries produces a set of colour coordinates or colour information values which may be described in the second colour space, which may be X₁₀Y₁₀Z₁₀Y₂, i.e. as:
Violet—X_{10V}Y_{10V}Z_{10V}Y_{2V}
Cyan—X_{10C}Y_{10C}Z_{10C}Y_{2C}
Yellow—X_{10Y}Y_{10Y}Z_{10Y}Y_{2Y}
Green—X_{10G}Y_{10G}Z_{10G}Y_{2G}
Red—X_{10R}Y_{10R}Z_{10R}Y_{2R}

As noted above, in some embodiments the colour coordinates in the second colour space may each also include a coordinate indicative of melanopsin excitation or metabrightness M_{V}, M_{C}, M_{G}, M_{Y}, M_{R}, respectively.

Step 230 comprises determining relative weightings of the plurality of the plurality of colour primaries, i.e. of the five colour primaries in the illustrated embodiment, to determine a target colour coordinate in which the tristimulus value determined using both 2° and 10° colour spaces are within the predetermined range, such as 10%. In the illustrated embodiment the weightings of the plurality of colour primaries are determined to ensure that Y₂ is within 10% of Y₁₀ as explained above.

In some embodiments, each primary is associated with a respective weighting. The weighting K is applied to each of the primary equations to generate output colour information values X_{10T}Y_{10T}Z_{10T}Y_{2T}. A relative weighting of each primary may be defined by the respective constant K to give the following primary equations:

X_{10T}=K_{V}*X_{10V}+K_{C}*X_{10C}+K_{G}*X_{10G}+K_{Y}*X_{10Y}+K_{R}*X_{10R}

Y_{10T}=K_{V}*Y_{10V}+K_{C}*Y_{10C}+K_{G}*Y_{10G}+K_{Y}*Y_{10Y}+K_{R}*Y_{10R}

Z_{10T}=K_{V}*Z_{10V}+K_{C}*Z_{10C}+K_{G}*Z_{10G}+K_{Y}*Z_{10Y}+K_{R}*Z_{10R}

Y_{2T}=K_{V}*Y2_{V}+K_{C}*X_{2C}+K_{G}*Y_{2G}+K_{Y}*X_{2Y}+K_{R}*X_{2R}

Wherein K_{V} denotes a weighting of the violet primary, K_{C} a weighting of the cyan primary, K_{G} a weighting of the green primary, K_{Y} a weighting of the yellow primary and K_{R} a weighting of the red primary.

In some embodiments, where the colour coordinates comprise a value indicative of melanopsin excitation or metabrightness, the step 230 comprises applying a weighting K to each of the primary equations to generate the output colour information values X_{10T}Y_{10T}Z_{10T}Y_{2T}M_{T}, where M_{T} is a target meta-brightness value. The relative weighting of each primary may be defined by the respective constant K to give the following primary equations:

X_{10T}=K_{V}*X_{10V}+K_{C}*X_{10C}+K_{G}*X_{10G}+K_{Y}*X_{10Y}+K_{R}*X_{10R}

Y_{10T}=K_{V}*Y_{10V}+K_{C}*Y_{10C}+K_{G}*Y_{10G}+K_{Y}*Y_{10Y}+K_{R}*Y_{10R}

Z_{10T}=K_{V}*Z_{10V}+K_{C}*Z_{10C}+K_{G}*Z_{10G}+K_{Y}*Z_{10Y}+K_{R}*Z_{10R}

Y_{2T}=K_{V}*Y2_{V}+K_{C}*X_{2C}+K_{G}*Y_{2G}+K_{Y}*X_{2Y}+K_{R}*X_{2R}

M_{T}=K_{V}*M_{V}+K_{C}*M_{C}+K_{G}*M_{G}+K_{Y}*M_{Y}+K_{R}*M_{R}

Thus, as a result of step 230, a plurality of weighting values are determined K_{V}, K_{C}, K_{G}, K_{Y}, K_{R} which ensure that Y₂ is within, for example, 10% of Y₁₀.

In some embodiments, steps 220 and 230 may be combined into a single step which takes the colour information values received in step 210, e.g. RGB values, and determines the plurality of weighting values such as K_{V}, K_{C}, K_{G}, K_{Y}, K_{R}. A matrix or other mathematical transformation may be applied to the colour information values received in step 210 to determine the weight values. Use of such direct transformation includes the mapping of the colour information values in the first colour space to the colour information values in the second colour space, as in step 220, although this step is not performed as a discrete step which outputs second colour space coordinates. In other words, steps 220 and 230 are effectively combined.

In some embodiments, the method 200 comprises a step 240 of outputting the image data comprising the output colour information values. By controlling the weighting values, as described above, to ensure that in some embodiments Y₂ is within the predetermined range of Y₁₀, advantageously a colour reproduction of the output image data may be controlled, whilst preventing or reducing a likelihood of the appearance of Maxwell's spot. In some embodiments, outputting the image data comprising the output colour information values may comprise providing the image data to another apparatus, such as a display device, or storing the image data in a data store such as a memory for use by the display device.

In some embodiments, step 240 may alternatively comprise outputting the second colour space coordinates such as X_{10T}Y_{10T}Z_{10T}Y_{2T}. Similarly step 240 may comprise outputting values of K_{V}, K_{C}, K_{G}, K_{Y} and K_{R}.

In some embodiments, the method 200 comprises an optional step 250 of generating an image according to the output colour information values. Step 250 may comprise illuminating a plurality of light emitters representing the plurality of colour primaries according to the output colour information values. For example, step 250 may comprise illuminating at least a portion of a display device according to the output colour information values.

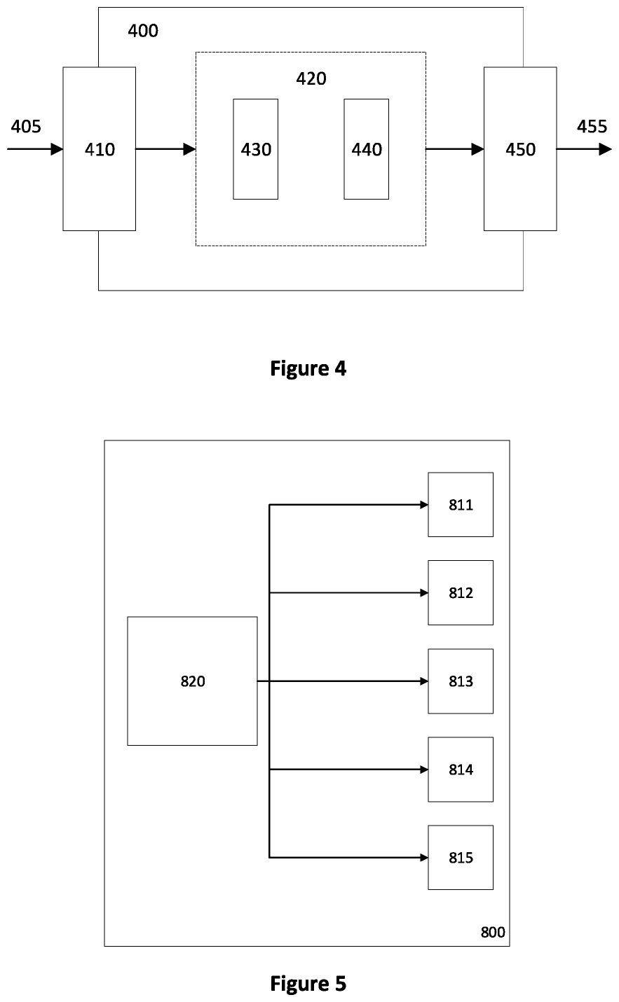

FIG. 4 illustrates an apparatus 400 according to an embodiment of the invention. The apparatus 400 may determine colour information values according to an embodiment of the invention. In some embodiments, the apparatus may implement a method according to an embodiment of the invention, such as that illustrated in FIG. 2 and described above

The apparatus 400 comprises an input means 410 for receiving image data 405 comprising colour information values in the input, or first, colour information space, a processing means 420 for mapping the received colour information values to second colour information values in the second colour space, as described above, and an output means 450 for outputting image data 455, wherein the image data comprises output colour information values.

The processing means 420 may comprise one or more processors electrically coupled to an electronic memory device having instructions stored therein. The input means 410 may comprise means for receiving one or more signals indicative of image data comprising a first plurality of colour information values, wherein said means comprises an electrical input coupled to the processing means 420 for receiving said one or more signals each indicative of the image data. The processing means 420 may further comprise the processor being configured to access the memory device and execute the instructions stored therein such that it is operable to map the colour information values in the first colour space of the image data via first and second tristimulus colour spaces reflecting two sets of cone spectral sensitivities, wherein the mapping comprises determining one or more colour information values in the second colour space based on each of the colour spaces reflecting two sets of cone spectral sensitivities such that one or more of the colour information values in the second colour space based on the first colour space is within a predetermined range of a second colour information value based on the second colour space. The output means 450 may comprise means for outputting one or more signals indicative of the image data comprising the second plurality of output colour information values, such as an electrical output electrically coupled to the processor for outputting said one or more signals.

In some embodiments, the input means 410 may be arranged to receive a plurality of colour information values in the first colour space that are each indicative of the image data, and may comprise a plurality of values indicative of RGB primaries or similar. In some embodiments, the plurality of colour information values in the first colour space may comprise discrete values. In some embodiments, the colour information values may be indicative of a spectral power distribution representative of the image data.

The processing means 420 may comprise a first module 430 for mapping the received colour information values of the image data to a tristimulus colour space reflecting a first set of cone spectral sensitivities. The processing means 420 may also comprise a second module 440 for mapping the received colour information values to a colour space reflecting a second set of cone spectral sensitivities. In some embodiments, the first colour space may comprise the CIE XYZ colour space. In some embodiments, first and second modules 430, 440 may be arranged to map the colour information values in the first colour space to tristimulus colour information values, such as CIE XYZ tristimulus values. As before, the first and second tristimulus colour spaces may be derived from the spectral sensitivities of the central 2° and 10° of visual space. In some embodiments, the processing means 420 may be arranged to map the colour information values to the 2 and the 10 degree XYZ tristimulus colour spaces and thus may be arranged to produce X₂Y₂Z₂ and X₁₀Y₁₀Z₁₀ colour information values respectively indicative of the image data.

In some embodiments, the processing means 420 may be arranged to map the plurality of colour information values in the first colour space such that one or more of the colour information values in the second colour space based on each of the two colour tristimulus spaces reflecting two sets of cone spectral sensitivities may be within a predetermined range of each other. In other words, the processing means 420 may be arranged to map by determining one or more colour information values in the second colour space based on each of the two tristimulus colour spaces reflecting two sets of cone spectral sensitivities via the first and second modules 430, 440 such that one or more of the second colour information values based on the first tristimulus colour space is within a predetermined range of a second colour information value based on the second tristimulus colour space.

In some embodiments the processing means 420 is arranged to map such that Y₂ and Y₁₀ differ by no more than 10%, however other colour information values and other predetermined ranges may be envisaged. In some embodiments, the predetermined range is 5%. In other embodiments, the predetermined range is 15%. As is described above, the mapping may still be arranged such that a perceived colour or colours of the image data is substantially maintained after mapping.

In some embodiments, the processing means 420 may be arranged to map such that a predetermined melanopsin response is elicited by the mapped image data. The melanopsin response may be produced by controlling a meta-brightness of the image data.

In some embodiments, the processing means 420 may further be arranged to map to a plurality of output colour information values. In some embodiments of the invention, the output colour information values may be defined as X_{10T}Y_{10T}Z_{10T}Y_{2T}M_{T}, according to first and second, i.e. 2° and 10°, cone fundamentals.

In some embodiments, the output means 450 may comprise a plurality of colour primaries. In some embodiments, at least four colour primaries are used. In some embodiments, five colour primaries are used, comprising at least some of violet, cyan, yellow, green, and red colour primaries. The output means 450 may, for example, comprise a visual display unit utilising four or five independently controllable colour planes.

FIG. 5 shows a device for light emission 800, according to an embodiment of the invention. The device 800 may be arranged to control the appearance of Maxwell's spot on surfaces illuminated by the device. The device 800 comprises a plurality of light emitting devices 811, 812, 813, 814, 815, each device being arranged to output light in a respective wavelength range, control means 820 for controlling the output of each of the plurality of light emitting devices, wherein the control means 820 is arranged to determine the respective weighting for each of the light emitting devices according to first and second tristimulus colour spaces, such that one or more of the colour information values of the combined output of emitters in a first tristimulus colour space is within a predetermined range of a second colour information value based on a second tristimulus colour space.

The control means device 800 may be arranged to execute an embodiment of the method 200 shown in FIG. 2 as described above, wherein the received image data comprises a target colour for emission or illumination.

As an example, it will be appreciated that the method 200 may also be applied to existing devices such as that described in US 2012/0259392 A1.

In some embodiments, the device for light emission 800 may comprise a visual display unit. In other embodiments, the device 800 may comprise an optical emitter such as a lightbulb. Each of the wavelength ranges may correspond to a colour primary, and in some embodiments may correspond to peak emission or transmission wavelengths for melanopsin excitation.

| Primary | Peak wavelength range | |
|---|---|---|
| Violet | <460 | nm |
| Cyan | 460-510 | nm |
| Green | 510-560 | nm |
| Yellow | 560-600 | nm |
| Red | >600 | nm |

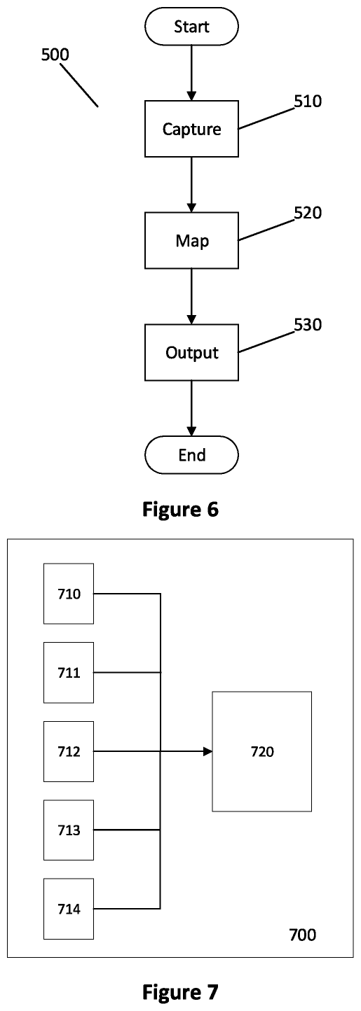

FIG. 6 illustrates a method 500 according to a further embodiment of the present invention. The method 500 is a method of mapping colour information values from captured images to generate output colour information values. The method 500 comprises steps to capturing 510 and mapping 520 colour information values directly to form image data representing a scene using a plurality of light detecting devices, or a light detecting device comprising a plurality of portions, such as a CCD, and outputting 530 the output colour information values 530. The mapping step 520 may be as described above in connection with the method 200 illustrated in FIG. 2.

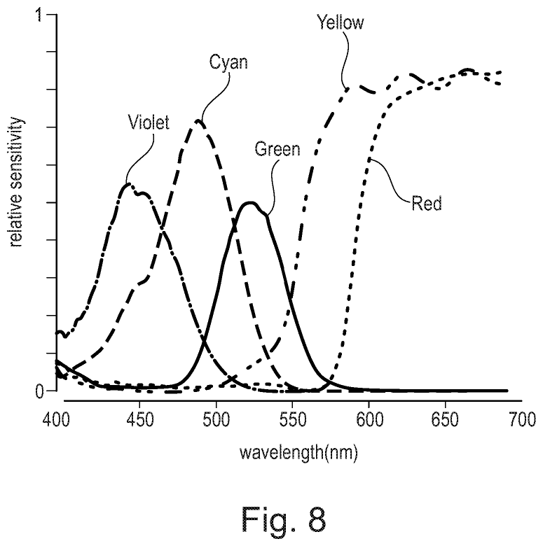

FIG. 7 illustrates an apparatus 700 according to a further embodiment of the present invention. The apparatus 700 is an image capture device 700. In an embodiment of the present invention, the image capture device 700 is configured to capture a plurality of colour information values from a scene. The image capture device 700 comprises a plurality of light detecting devices 710, 711, 712, 713, 714, each being arranged to detect light in a respective wavelength range. It will also be appreciated that an imaging device comprising a plurality of portions each sensitive to light in the respective wavelength ranges may be used. The device 700 further comprises a means or unit 720 for processing and outputting the image data. The output colour information comprises four or more colour information values, one or more of which describes colour in a first tristimulus colour space and one of which describes colour in a second tristimulus colour space reflecting different sets of cone spectral sensitivities. In some embodiments the first tristimulus colour space is the 2° colour space and the second tristimulus colour space is the 10° colour space. The imaging device in one embodiment comprises a plurality of spectral channels. These spectral channels have different spectral sensitivity functions. Example, spectral sensitivity functions are shown in FIG. 8. Advantageously an image capture device according to an embodiment of the invention may be operable to better capture colours in a scene.

Each of the detectors 710-714 can be described in terms of their sensitivity to each of the coordinates of the at least four colour space, such as a 4 or 5D colour space, such that ^{s710}X₁₀ describes the normalised sensitivity of sensor 710 to light in the X₁₀ coordinate, etc. The processor 720 is arranged to calculate X_{10T} for each portion of the image based upon the intensity recorded for some or all of the 5 detectors—⁷¹⁰I; ⁷¹¹I . . . etc multiplying by the sensitivity for each detector in the X₁₀ coordinate. In one embodiment, the processor is arranged to determine:

X_{10T}=⁷¹⁰I.^{s710}X₁₀+⁷¹¹I.^{s711}X₁₀+⁷¹²I.^{s712}X₁₀+⁷¹³I.^{s713}X₁₀+⁷¹⁴I.^{s714}X₁₀;

The same determination may be made by the processor 720 for the other colour coordinates to determine X_{10T}Y_{10T}Z_{10T}Y_{2T}M_{T} which may be output by the imaging device 700. In some embodiments, the imaging device may apply step 230 of the method shown in FIG. 2 to translate X_{10T}Y_{10T}Z_{10T}Y_{2T}M_{T} into weightings for output primaries (i.e. K_{C}K_{Y} etc).

In some embodiments, determination of the intermediate values of X_{10T}Y_{10T}Z_{10T}Y_{2T}M_{T} may be omitted and the values of ⁷¹⁰I; ⁷¹¹I used to determine the weightings for the output primaries (i.e. K_{C}K_{Y} etc), wherein the weightings are implicitly be based upon the first and second tristimulus colour spaces. Thus, the imaging device effectively performs steps 220 and 230 of the method illustrated in FIG. 2, which may be combined into a single step to determine the weightings.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing an apparatus or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A computer-implemented method of processing colour image data, comprising:
determining output colour information values based on first and second tristimulus colour spaces indicative of first and second cone spectral sensitivity functions, wherein the determining comprises determining a first one of the output colour information values based on a first tristimulus colour space and determining a second one of the output colour information values based on a second tristimulus colour space to be within a predetermined range of the first one of the output colour information values; and
outputting the output colour information values.

2. The method of claim 1, comprising:
receiving image data comprising colour information values in a first colour space;
wherein the determining the output colour information values comprises mapping the colour information values in the first colour space to the output colour information values via the first and second tristimulus colour spaces, such that the first one of the output colour information values based on the first tristimulus colour space is within the predetermined range of the second one of the output colour information values based on the second tristimulus colour space; and
outputting the image data comprising the output colour information values.

3. The method of claim 2, wherein a perceived colour of the image data is substantially maintained after the mapping to the output colour information values.

4. The method of claim 1, wherein the output colour information values comprises a plurality of discrete values.

5. The method of claim 2, wherein the colour information values in the first colour space comprises a plurality of discrete values.

6. The method of claim 1, wherein the first tristimulus colour space comprises one of a 10° X₁₀Y₁₀Z₁₀ tristimulus colour space and a 2° X₂Y₂Z₂ tristimulus colour space.

7. (canceled)

8. The method of claim 1, wherein the output colour information values are in a second colour space.

9. The method of claim 8, wherein the second colour space is a X₁₀Y₁₀Z₁₀Y₂ colour space.

10. The method of claim 1, wherein the output colour information value based on the first and second tristimulus colour spaces within the predetermined range is a Y₁₀ and Y₂ value, respectively.

11. The method of claim 1, wherein the predetermined range is between 2% and 18%.

12. The method of claim 2, wherein the mapping is arranged to produce a predetermined melanopsin response.

13. (canceled)

14. The method of claim 1, wherein the mapping comprises determining a weighting value associated with at least some of a plurality of colour primaries, wherein the weighting value is determined such that the second one of the output colour information values based on the second tristimulus colour space is within the predetermined range of the first one of the output colour information values.

15. The method of claim 14, comprising determining a plurality of weighting values, each being associated with one of the plurality of colour primaries.

16. The method of claim 1, wherein outputting the output colour information values comprises utilising at least four colour primaries.

17. (canceled)

18. (canceled)

19. An apparatus for processing colour image data, comprising:
processing means arranged to determine output colour information values based on first and second tristimulus colour spaces indicative of first and second cone spectral sensitivity functions, wherein the determining comprises determining a first one of the output colour information values based on a first tristimulus colour space and determining a second one of the output colour information values based on a second tristimulus colour space to be within a predetermined range of the first one of the output colour information values; and
output means arranged to output colour information values.

20. The apparatus of claim 19, comprising:
input means arranged to receive image data comprising colour information values in a first colour space;
wherein the processing means is arranged to determine the output colour information values by mapping the colour information values in the first colour space to the output colour information values via the first and second tristimulus colour spaces, such that the first one of the output colour information values based on the first tristimulus colour space is within the predetermined range of the second one of the output colour information values based on the second tristimulus colour spaces; and
wherein the output means is arranged to output the image data comprising the output colour information values.

21. The apparatus of claim 19, wherein the processing means is arranged to determine the output colour information values such that the output colour information value based on the first and second tristimulus colour spaces within the predetermined range is a Y₁₀ and Y₂ value, respectively.

22. (canceled)

23. The apparatus of claim 19, wherein the processing means is arranged to determine a weighting value associated with at least some of a plurality of colour primaries, wherein the weighting value is determined such that the second one of the output colour information values based on the second tristimulus colour space is within the predetermined range of the first one of the output colour information values.

24. Computer software tangibly stored on a computer-readable medium which, when executed by a computer, is arranged to perform a method according to claim 1.

25. A device for light emission, comprising:
a plurality of light emitting devices, each device being arranged to output light in a respective wavelength range;
control means for controlling an output of each of the plurality of light emitting devices, wherein the control means is arranged to determine the respective output of each of the light emitting devices according to first and second tristimulus colour spaces, such that one or more colour information values of a summed output of the light emitting devices based on the first colour space is within a predetermined range of one or more colour information values based on the second colour space.
